(19) United States
(12) Patent Application Publication
(10) Pub. No.: US 2002/0083807 A1
(43) Pub. Date: Jul. 4, 2002

(54) Arbor

(76) Inventor: Brian Gascoyne, Killamarsh (GB)

Correspondence Address: TREXLER, BUSHNELL, GIANGIORGI,, BLACKSTONE & MARR, LTD., 105 WEST ADAMS STREET--36TH FLOOR, CHICAGO, IL, 60603, US

(21) Appl. No.: 10/001,456

(22) Filed: Oct. 24, 2001

(30) Foreign Application Priority Data
Oct. 25, 2000 (GB) 0026051.3

(51) Int. Cl. B23B 27/00; B23B 31/00

(52) U.S. Cl. 82/160; 82/168

(57) ABSTRACT

An arbor 1 having an axis of rotation 2 comprises a body member 3 having end 4 with flats so that it may be drivably secured in a spindle or chuck of a machine or machine tool. The body member 3 has a co-axial socket 5 provided at its opposite, cutting end 6 to receive a shank of a rotary cutter (not shown), the shank having, in the conventional manner, at least one flat. The arbor 1, further comprises a collar 7 carried at the cutting end 6, which collar 7 is biassed by a torsion spring 8 to an active position and is manually rotatable, within limits, against the spring bias, to an inactive position. A cam surface 9 is provided internally of the collar 7 and a segmental key 10 which is biassed radially outwardly by a pair of coil compression springs 11 to a cutter release position, has a flat, abutment surface 12, and an opposed, curved, displacement surface 13 engageable by the cam surface 9, and is also carried by the cutting end of the arbor, which key 10 is upon suitable manual rotation of the collar permitted to be displaced under its spring bias to the cutter release position, in which the key 10 is clear of the socket 5 to permit insertion, or removal, of a shank of a cutter into, or from, the socket. Upon manual release of the collar 7 permitting rotation of the collar under its spring bias, to an active position, at least the abutment surface 12 of the key 10 penetrates a portion of the socket 5 to engage a, or the, flat of an inserted cutter shank, with the cam surface 9 of the collar maintaining engagement with the displacement surface 13 of the key 10 to maintain the key 10 in its active position.

### FIELD OF THE INVENTION

This invention relates to an arbor adapted to be fitted a clamping end to, a chuck, spindle etc of a machine, or machine tool, and at a cutting end to receive and clamp a cutter.

### BACKGROUND OF THE INVENTION

A known arbor comprises, towards its cutting end, a pair of tapped, radial holes extending at 90° to one another. Each hole receives a grub screw with a recessed hexagon head to receive an Allen key, so that the grub screws may be screwed in, to engage flats provided on a shank of the cutter, to clamp the shank onto a receiving socket of the cutting end.

It is not unknown for Allen keys to be lost, for only wrong sized Allen keys to be available, or for the grub screws to be cross-threaded, particularly for on site or remote locations, such as railway track, where a solution might not readily be available.

Furthermore, only the ends of the grub screws are in contact with the flats, providing relatively limited effective clamping areas.

### OBJECT OF THE INVENTION

A basic object of the invention is the provision of an improved arbor.

### SUMMARY OF THE INVENTION

According to the present invention, there is provided an arbor having a longitudinal axis of rotation, comprising a body member having a clamping end adapted to be drivably secured in a spindle or chuck etc of a machine or machine tool, and having a co-axial socket at its opposite, cutting end to receive a shank of a rotary cutter, the shank having at least one flat, characterised in that:

(i) a collar carried by the cutting end of the arbor, which collar is spring biassed to an active position and is manually rotatable, within limits, against the spring bias, to an inactive position;

(ii) a cam surface provided internally of the collar; and

(iii) a key which is spring biassed radially outwardly to cutter release position, has a flat, abutment surface to engage a corresponding flat of a shank of a cutter, has an opposed, curved, displacement surface engageable by the cam surface of the collar, and is also carried by the cutting end of the arbor and which key upon suitable manual rotation of the collar is permitted to be displaced radially outwardly, under its spring bias to the cutter release position, in which the key is clear of the socket to permit insertion, or removal, of a shank of a cutter into, or from, the socket, and upon manual release of the collar permitting rotation of the collar under its spring bias, displaces the key radially inwardly to a cutter clamping position, in which at least the abutment surface of the key penetrates a portion of the socket to engage a, or the, flat of an inserted cutter shank, with the cam surface of the collar maintaining its engagement with the displacement surface of the key, to maintain the key in its cutter clamping position.

### ADVANTAGES OF THE INVENTION

The arbor in accordance with the invention provides a quick release, screwless action, avoiding the drawbacks of grub screws, and the time taken to tighten or release such screws during the fitting or replacement of a cutter.

Furthermore, the abutment surface of the key provides a substantially increased contact area with the engaged flat of the cutter shank.

Furthermore, the arbor in accordance with the invention requires but a single flat, and hence can accommodate a miscellany of cutters of different manufacturers having 1, 2, 3 or 4 flats on the cutter shank.

### PREFERRED OR OPTIONAL FEATURES OF THE INVENTION

The key is of segmental shape having an arcuate displacement surface in engagement with the cam surface of the collar.

The cutting end of the body member is provided with a transverse slot to receive the key.

The transverse slot is provided with two spaced-apart blind holes, each to receive one end of a coil compression spring, which at their other ends bear on the abutment surface of the key to bias the latter radially outwardly towards its cutter release position, clear of the socket.

The spring bias on the collar is provided by a torsion spring, one end of which engages an aperture in the body member, and the other end of which engages an aperture in the collar, to rotationally bias the collar to a position in which its cam surface urges the key radially inwardly into its cutter clamping position, penetrating the socket.

The body member is provided with a circumferential flange against which one end of the collar is adapted to abut, with the collar being retained on the cutting end of the body member by a circlip.

The one clamping of the body member is appropriately profiled eg by having a Morse taper, for the spindle etc of a drilling machine etc in which it is to be clamped.

Operation

It follows that, to insert a cutter shank into an arbor in accordance with the invention, the collar is firstly manually rotated against its spring bias to permit the curved, displacement surface of the key to ride down the cam surface of the collar to permit the key to be radially retracted from its cutter clamping position by its spring bias. Once fully inserted (but probably not clamped unless, by chance the, or a flat, of the cutter shank were opposite the key), the collar is manually released permitting the spring bias on the collar to rotate the collar whereby the curved displacement surface of the key rides up the cam surface of the collar to overcome the radially outward bias on the key, so that, with slight manual rotation of the cutter, flat-to-key engagement is found, with removal of a cutter following a reversal of this procedure.

One embodiment of arbor in accordance with the invention is shown by way of example only, in the accompanying drawings in which:

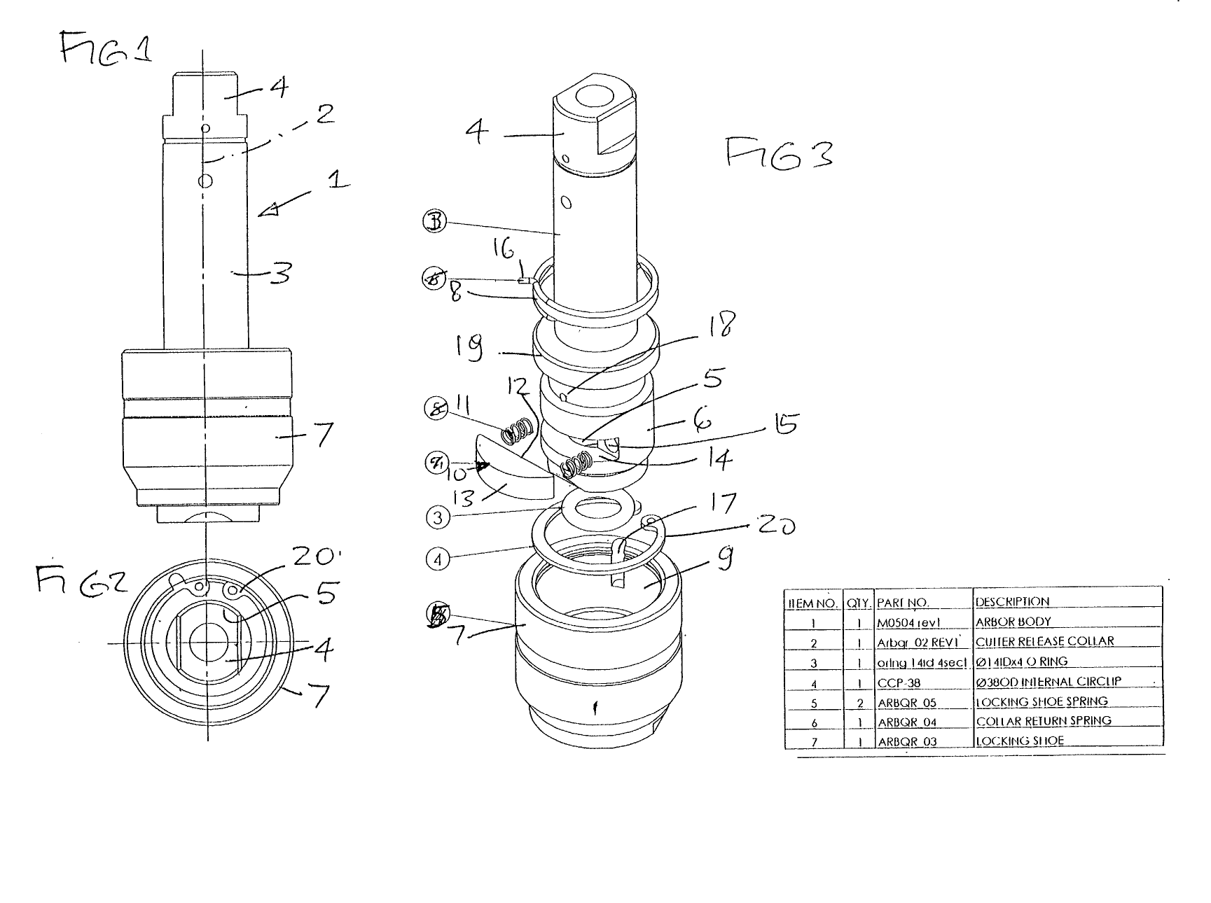

FIG. 1 is a side elevation of an arbor in accordance with the invention;

FIG. 2 is an end elevation of FIG. 1; and

FIG. 3 is an exploded view of the arbor of FIGS. 1 and 2.

An arbor 1 has an axis of rotation 2 and comprises a body member 3 having a clamping end 4 provided with flats so that it may be drivably secured in a spindle or chuck of a machine or machine tool. The body member 3 has a co-axial socket 5 provided at its opposite, cutting end 6 to receive a shank of a rotary cutter (not shown), the shank having, in the conventional manner, at least one flat. The arbor 1, further comprises a collar 7 carried at the cutting end 6, which collar 7 is biassed by a torsion spring 8 to an active position and is manually rotatable, within limits, against the bias of spring 8, to an inactive position. A cam surface 9 is provided internally of the collar 7 and a segmental key 10, which is biassed radially outwardly by a pair of coil compression springs 11 to a cutter release position, has a flat, abutment surface 12, and an opposed, curved, displacement surface 13 engageable by the cam surface 9, and is also carried by the cutting end 6 of the arbor 1. Upon sufficient manual rotation of the collar 7 against its spring bias, the key 10 is permitted to be displaced under the bias of its springs 11 to the cutter insertion or removal position, in which the key 10 is clear of the socket 5 to permit insertion or removal of a shank of a cutter into the socket 5. Upon manual release of the collar 7, permitting rotation of the collar 7 under its spring bias, to an active position, the cam surface 9 displaces the key 10 radially inwardly against the bias of springs 11 until at least the abutment surface 12 of the key 10 penetrates a portion of the socket 5 to engage a, or the, flat of an inserted cutter shank, with the cam surface 9 of the collar maintaining its engagement with the displacement surface 13 of the key 10 to maintain the key 10 in its active position.

The key 10 is received in a transverse slot 14 in the cutting end 6 of the body member 3, whilst each coil compression spring 11 is located in a blind bore 15. The torsion spring 8 has one end 16 adapted to engage an aperture 17 while its other end adapted to engage an aperture 18 in the body member 3. The body member 3 is also provided with a circumferential flange 19 against which a portion of the collar 7 abuts to be retained by a circlip 20.

What I claim is:

1. An arbor having a longitudinal axis of rotation and comprising a body member having a clamping end adapted to be drivably secured in a spindle or chuck of a machine or machine tool, and having a co-axial socket at its opposite, cutting end to receive a shank of a rotary cutter, said shank having at least one flat, wherein:
(i) a collar is carried by said cutting end of said arbor, which collar is spring biassed to an active position and is manually rotatable, within limits, against said spring bias, to an inactive position;
(ii) a cam surface is provided internally of said collar; and
(iii) a key, which is spring biassed radially outwardly to cutter release position, has a flat, abutment surface to engage a corresponding flat of a shank of a cutter, has an opposed, curved, displacement surface engageable by said cam surface of said collar, and is also carried by said cutting end of said arbor and which key upon suitable manual rotation of said collar is permitted to be displaced radially outwardly, under its spring bias, to said cutter release position, in which said key is clear of said socket to permit insertion, or removal, of a shank of a cutter into, or from, said socket, and upon manual release of said collar permitting rotation of said collar under its spring bias, displaces said key radially inwardly to a cutter clamping position, in which at least said abutment surface of said key penetrates a portion of said socket to engage a, or the, flat of an inserted cutter shank, with said cam surface of said collar maintaining its engagement with said displacement surface of said key, to maintain said key in its cutter clamping position.

2. An arbor, as claimed in claim 1, wherein said key is of segmental shape having an arcuate displacement surface in engagement with said cam surface of said collar.

3. An arbor as claimed in claim 1, wherein said cutting end of said body member is provided with a transverse slot to receive said key.

4. An arbor as claimed in claim 3, wherein said transverse slot is provided with two spaced-apart blind holes, each to receive one end of a coil compression spring, which at their other ends bear on said abutment surface of said key to bias the latter radially outwardly towards its cutter release position, clear of said socket.

5. An arbor as claimed in claim 1, wherein a torsion spring provides said spring bias on said collar, one end of which torsion spring engages an aperture in said body member, and the other end of which torsion spring engages an aperture in said collar, to rotationally bias said collar to a position in which its cam surface urges said key radially inwardly into its cutter clamping position, penetrating said socket.

6. An arbor as claimed in claim 1, wherein said body member is provided with a circumferential flange against which one end of said collar is adapted to abut, with said collar being retained on said cutting end of said body member by a circlip.
